(19) United States
(12) Patent Application Publication
(10) Pub. No.: US 2015/0292715 A1
(43) Pub. Date: Oct. 15, 2015

(54) CHEERING DEVICE

(71) Applicant: HANAM ARTEC CO., LTD., Uiwang-si (KR)

(72) Inventor: Jai Han PARK, Anyang-si (KR)

(21) Appl. No.: 14/686,296

(22) Filed: Apr. 14, 2015

(30) Foreign Application Priority Data
Apr. 15, 2014 (KR) 10-2014-0044838

(51) Int. Cl. F21V 13/04; F21V 21/40; F21K 99/00

(52) U.S. Cl. CPC F21V 13/045; F21K 9/50; F21V 21/406; F21Y 2101/02

(57) ABSTRACT

The present invention is related to a cheering device, comprising a light emitting portion emitting light; a holder grabbable and supporting the light emitting portion; at least one light emitting diode, contained in the holder, emitting light; and a lens portion condensing the ray of light emitted by the light emitting diode and diffusing the condensed light to the light emitting portion.

### CROSS-REFERENCE TO RELATED APPLICATION

This application claims the priority of the Korean Patent Application No. 10-2014-0044838, filed on Apr. 15, 2014 in the Korean Intellectual Property Office (KIPO), and all the benefits accruing therefrom under 35 U.S.C. §119, the contents of which in their entirety are herein incorporated by reference.

### TECHNICAL FIELD

The present invention is related to a cheering device, and more particularly a cheering device equipped with a lens condensing and diffusing the light emitted by a light emitting diode.

### BACKGROUND ART

In general, cheering devices with auditory aids such as a horn, a whistle, or a stick tube are being widely used in order for improving cheering effect in all sorts of outdoor sports games, concerts, and events.

Recently, cheering devices using a personal lighter, a firecracker, a fluorescence rod, and a light emitting diode are used in order for uplifting atmosphere and maximizing the visual effect at all sorts of sports games, concerts, and events taking place indoor or at night.

Korea utility model registration No. 20-0319280 discloses the related art on a batteryless light emitting cheering device using piezo cable.

The conventional cheering device disclosed is a batteryless light emitting cheering device using electric current generated from piezo cable, wherein the light emitting diode emits the light of various colors according to different strength of electric current, generated from the piezo cable, depending on the intensity of shaking the device.

However, since the brightness of light, emitted by such conventional light emitting diode cheering device, varies according to different strength of electric current generated from piezo cable depending on the intensity of shaking, not only an expensive high power consuming light emitting diode is required for emitting the light with higher brightness, but also the elderly or children get easily tired when using the cheering device due to intense shaking, resulting in lost interest in cheering.

### DISCLOSURE OF INVENTION

### Technical Problem

Considering the above mentioned issue, the present invention is designed to provide a cheering device which adopts a low power consuming light emitting diode with low applied voltage while providing the same luminous effect as those with the light emitting diode with high brightness and high power consumption requiring high applied voltage, and wherein power consumption can be reduced as the use of light emitting diode with high brightness is unnecessary, and thus the user's fatigue decreases and the user's interest in cheering can be enhanced.

### Technical Solution

To achieve the above mentioned effects, the present invention is to provide a cheering device comprising a light emitting portion; a holder grabbable and supporting the light emitting portion; at least one light emitting diode contained in the holder and emitting light; and a lens portion condensing the ray of light emitted by the light emitting diode and diffusing the condensed light to the light emitting portion.

At this, the light emitting portion may further include a reflecting member reflecting and penetrating the light released from the lens to be evenly diffused.

The lens portion may include a lens body diffusing the light emitted by the light emitting diode to the light emitting portion; and a lens holder supporting the lens body on the holder.

The lens body may include a condensing lens portion condensing the light emitted by the light emitting diode; and a diffusing lens portion diffusing the light passed through the condensing lens portion.

### Advantageous Effects

According to the present invention, equipped with the lens portion condensing and diffusing the light emitted by the light emitting diode, the cheering device using a low power consuming light emitting diode with low applied voltage may also provide the same luminous effect as those using a high power consuming light emitting diode with high brightness and high applied voltage. Power consumption may also be reduced as the use of high-brightness light emitting diode is unnecessary. As a result, the user's fatigue may decrease and the interest in cheering may be increased.

### BRIEF DESCRIPTION OF THE DRAWINGS

FIG. 1 is a perspective diagram illustrating one exemplary embodiment of the present invention.

FIG. 2 is a longitudinal sectional view of FIG. 1,

FIG. 3 is a perspective diagram illustrating the lens portion of FIG. 2,

FIG. 4 is an exploded perspective view of FIG. 3,

FIG. 5 is a drawing illustrating the reflection of the light emitted by the light emitting diode on the cheering device of FIG. 1.

FIG. 6 is showing the result of measurement of the beam angle of the cheering device according to the present invention.

FIG. 7 is showing the result of measurement of the beam angle of the comparison target.

FIG. 8 is showing the result of measurement of the brightness for the red-colored light emitting diode of the cheering device according to the present invention.

FIG. 9 is showing the result of measurement of the brightness for the red-colored light emitting diode of the comparison target.

FIG. 10 is showing the results of comparative measurement of the brightness by position on the light emitting portion of the cheering device according to the present invention, and that of the comparison target.

### BEST MODE OF CARRYING OUT THE INVENTION

The present disclosure will be described in detail in reference with appended drawings.

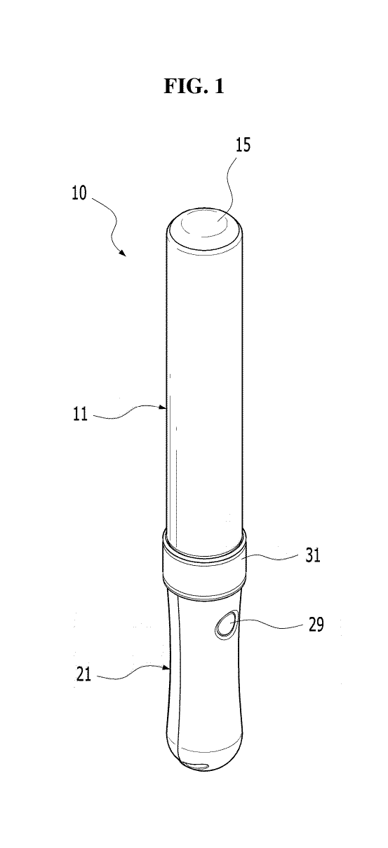

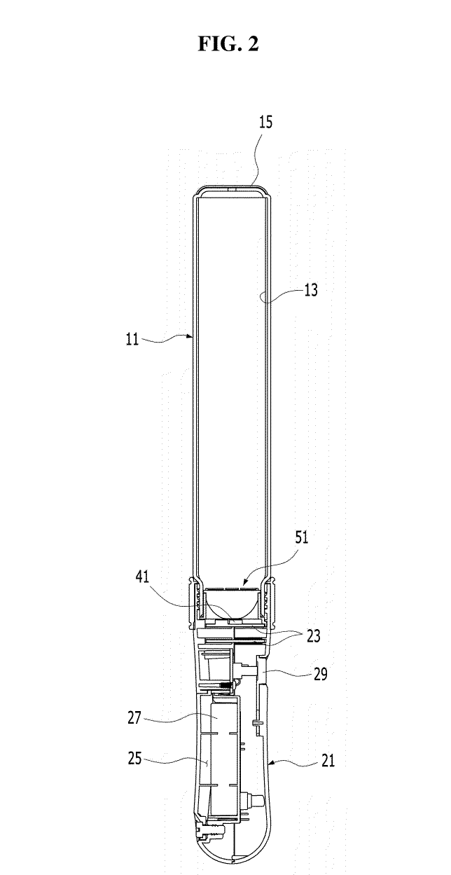

FIG. 1 and FIG. 2 are illustrating a cheering device according to one exemplary embodiment of the present invention.

As shown by the drawings, a cheering device (10) according to one exemplary embodiment of the present invention includes a light emitting portion (11), a holder (21), a light emitting diode (41), and a lens portion (51).

A light emitting portion (11), made of a transparent material, emits the light released from a lens portion (51). The light emitting portion (11) of the exemplary embodiment has a form of hollow round bar with both ends open, but the form is not limited thereto, and the form of the light emitting portion (11) can be modified in many different ways.

Meanwhile, on the inside of the light emitting portion (11) a reflecting member (13) is arranged for reflecting and penetrating the light released from the lens portion (51) to be evenly diffused.

Although the present exemplary embodiment is describing the reflecting member (13) in the form of sheet arranged on the inside of the light emitting portion (11), the method of arranging it is not limited thereto; for example, the light emitting portion (11) itself may contain a structure material for the reflecting member (13).

At this, the reflecting member (13) can be selectively included as necessary. In case the light emitting portion (11) is not equipped with the reflecting member (13), the light transmitted from the lens portion (51) is directly emitted to the outside through the light emitting portion (11).

In addition, in order not to obstruct the audience's field of vision, the rear side of the light emitting portion (11) can be made of semitransparent material while the front is made of transparent material. Thus, it is possible to prevent partially the light released by the lens portion (51) from emitted though the rear side while the light is emitted through the front side of the light emitting portion (11).

One of the open ends of the light emitting portion (11) is equipped with a covering member (15) preventing the light flowed into the light emitting portion (11) from releasing out though the open hole.

A holder (21) has a form of grabbable hollow round bar of a certain length with one open end. The holder (21) is combined to the open end of the light emitting portion (11) by a combining ring (31) in order for the open end of the holder (21) being connected to that of the light emitting portion (11), supporting the light emitting portion (11)

Meanwhile, a circuit board (23), contained in the holder (21), is equipped with a microprocessor (not shown) wherein an operation program controlling the motion of the light emitting diode (41), particularly a flickering, is built.

In addition, on the inside of the holder (21), a battery compartment portion (25) accepting a battery (27) is arranged for providing the circuit board (23) and the light emitting diode (41) with power. On the outside of the holder (21), a power switch (29) is arranged for turning on and off the power authorized from the battery (27) to the circuit board (23) and the light emitting diode (41).

A plurality of light emitting diodes (41) presenting different colors are arranged on the circuit board at an optimal interval. Contained in the holder (21), they emit light. Different colors presented by a plurality of light emitting diodes (41) uplifts the atmosphere and arouses the user's interest by maximizing visual effect.

According to the present disclosure, the light emitting diode (41) inexpensive, subminiature, and low power consuming, requiring low applied voltage, can be adopted. At this, only one light emitting diode (41) may be arranged.

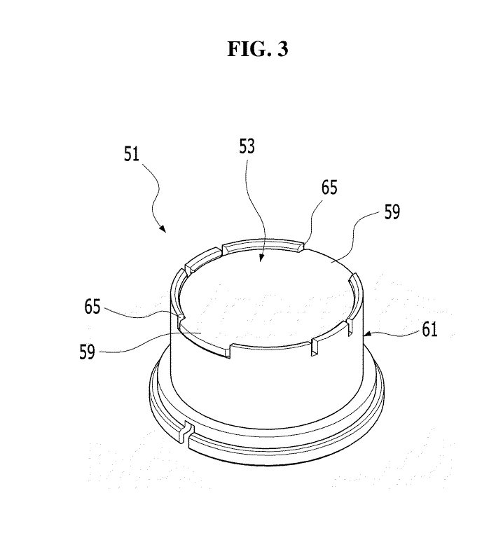

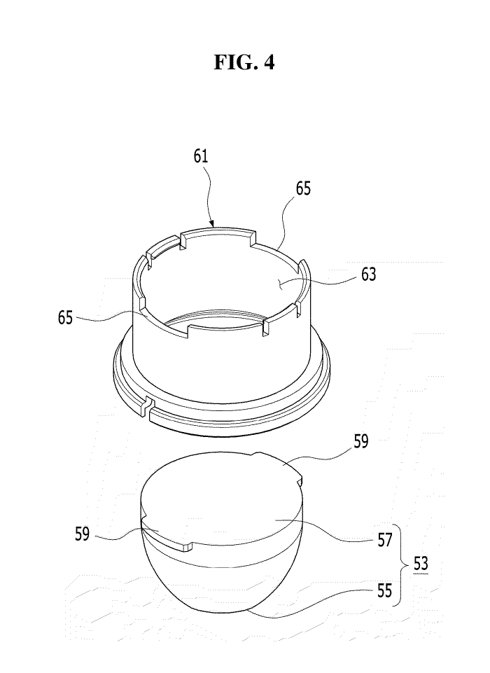

A lens portion (51), contained in the holder (21), condenses the ray of light emitted by the light emitting diode (41) and diffuses the condensed light to the light emitting portion (11). The lens portion (51), as shown by FIG. 3 and FIG. 4, includes a lens body (53) diffusing the light emitted by the light emitting diode (41) to the light emitting portion (11), and a lens holder (61) supporting the lens body (53) on the holder (21).

The lens body (53), in the form of a dome made of transparent material, includes a condensing lens portion (55) and a diffusing lens portion (57).

A condensing lens portion (55), forming the protruding part of the lens body (53), is arranged facing each of the light emitting diode (41) and condenses the light dispersedly emitted by each of the light emitting diode (41).

A diffusing lens portion (57) forms the flat area of the lens body (53), and is arranged toward the light emitting portion (11) to diffuse the light passed through the condensing lens portion (55). On the circumference of the diffusing lens portion (57), a pair of bumps (59) is partially protruded in a radial direction of the diffusing lens portion (57). A pair of bumps is fitted into a groove (65) of a lens holder (61) which will be described hereinafter. Although not shown by the drawings, on the flat surface of the diffusing lens portion (57), a prism sheet containing a Fresnel lens may be arranged in order for further increase in brightness and output of the light.

A lens holder (61) has a form of cylinder with both ends open. On the inside of the lens holder (61), a body holding portion (63) holding the lens body (53) is formed. On the circumference of the open hole, heading toward the light emitting portion (11), of the lens holder (61), a pair of grooves (65) is formed. A pair of bumps (59) of the lens body (53) is fitted into this pair of grooves (65), respectively.

Accordingly, the lens body (53) is combined into the body holding portion (63) of the lens holder (61), and the bumps (59) of the lens body (53) are fitted into the grooves (65) of the lens holder (61) at the same time. Consequently, the lens body (53) forms the lens portion (51) by being tightly combined into the lens holder (61).

The following is an explanation on the usage and operation of the cheering device (10) of the present disclosure according to such structure.

When the user, holding the holder (21) by his or her hand, selects the power switch (29) to permit power, the power of battery (27) is authorized to the microprocessor and the light emitting diode (41) of the circuit board (23).

According to the operation program built in the microprocessor of the circuit board (23), each of the light emitting diode (41) lights up simultaneously or selectively, and directs a beam to the lens body (53) of the lens portion (51).

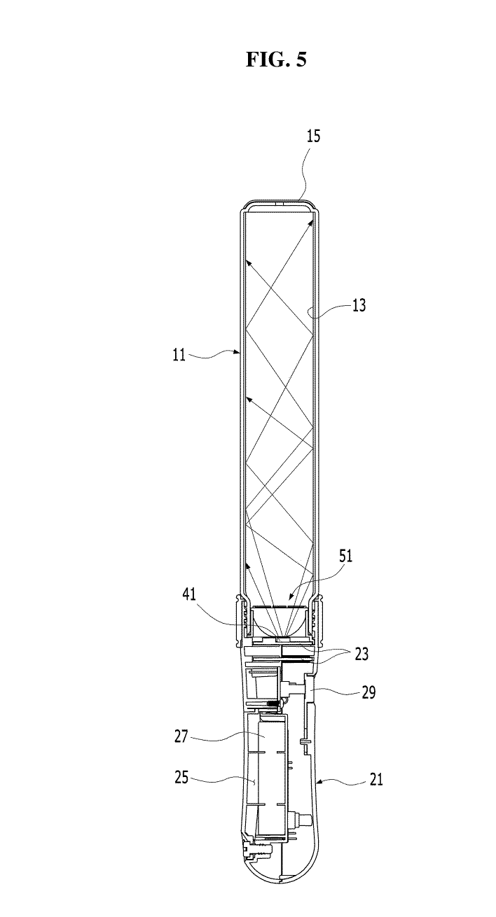

The light received in the lens body (53), as shown by FIG. 5, is condensed in the condensing lens portion (55) of the lens portion (51), passes through the diffusing lens portion (57) to be diffused to the light emitting portion (11). The light is reflected and penetrated by the reflecting member (13) in order to be evenly diffused, and emitted out of the light emitting portion (11).

As such, the light emitted out of the light emitting portion (11) enhances decoration and entertainment effects as well as cheering effect not only for the user but also for the other audiences around, uplifting the atmosphere of all sorts of sports games or events.

Meanwhile, the pictures below are showing the results of comparative measurement of the beam angle and the brightness of the cheering device (10) according to the present disclosure, and those of the comparison target device which has the same form with the present disclosure, but is equipped with the high-brightness light emitting diode (41) instead of a lens.

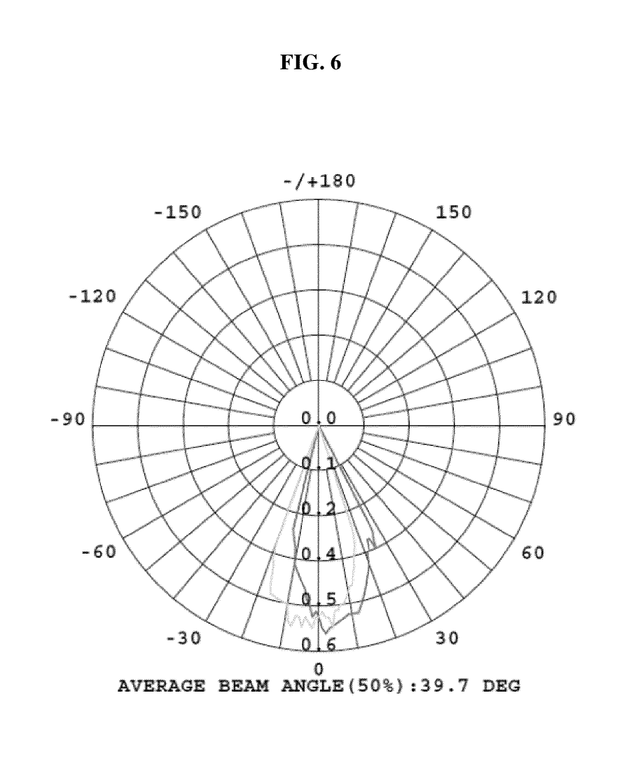

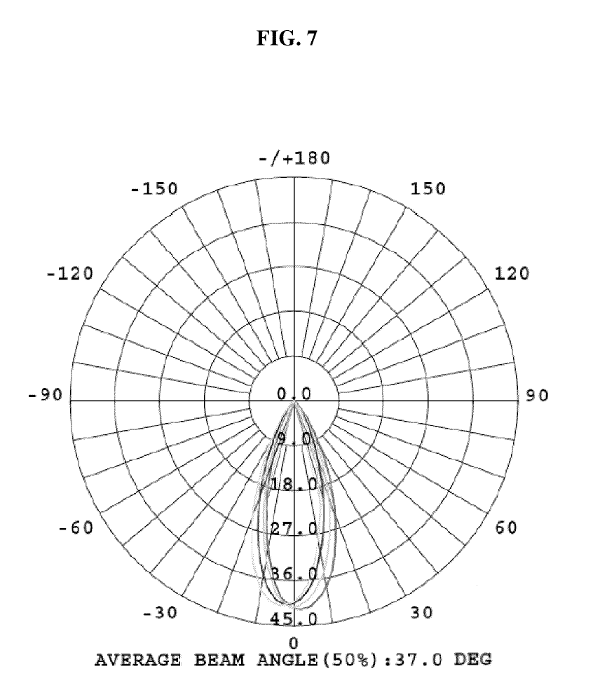

FIG. 6 is showing the result of measurement of the beam angle of the cheering device (10) according to the present disclosure, and FIG. 7 is showing that of the comparison target.

From the result of measurement of the beam angle, the beam angle of the cheering device (10) of the present disclosure is 39.7 degree, higher than that of the comparison target.

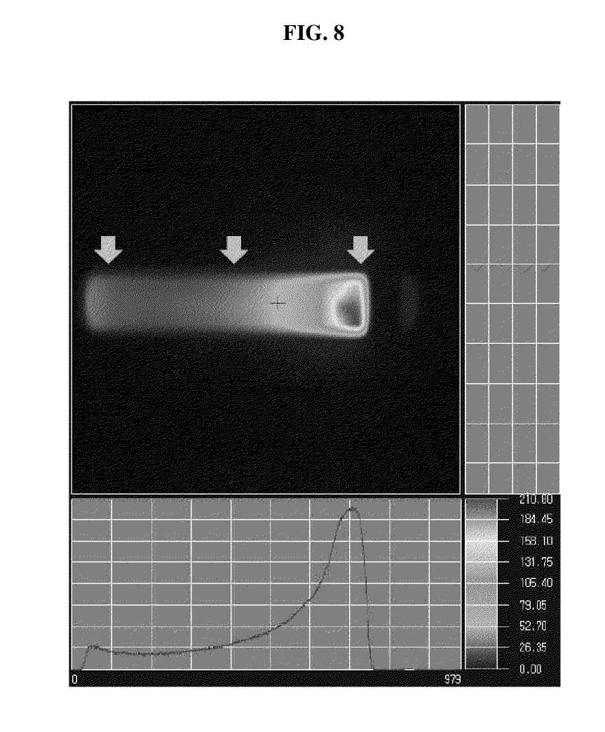

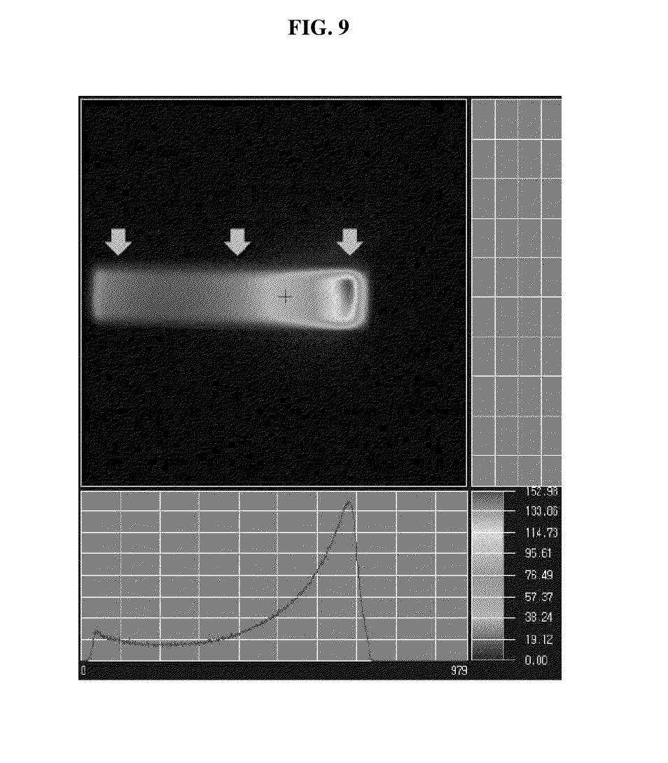

FIG. 8 is showing, as an example, the result of measurement of the brightness for the red-colored light emitting diode (41) of the cheering device according to the present disclosure, and FIG. 9 is showing that of the comparison target.

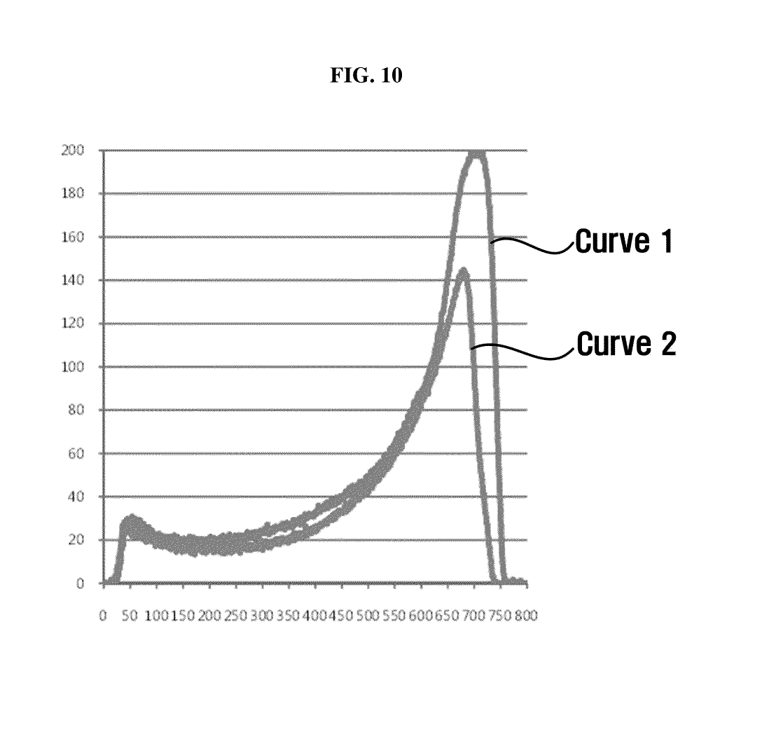

FIG. 10 is showing the results of comparative measurement of the brightness by position on the light emitting portion (11) of the cheering device (10) according to the present disclosure, and that of the comparison target.

The curve 1 of FIG. 10 indicates the result of measurement of brightness of the cheering device (10) according to the present disclosure, and the curve 2 indicates that of the comparison target.

In addition, Table 1 is showing the digitized values of the important elements of Graph 1.

TABLE 1

| Position for comparison | The cheering device of | The comparison |
|---|---|---|
| of brightness | the present disclosure | target |
| Lowest point of the light | 200 cd/m² | 145 cd/m² |
| emitting portion | | |
| Center of the light emitting | 30 cd/m² | 23 cd/m² |
| portion | | |
| 10 mm point from the top of | 30 cd/m² | 29 cd/m² |
| the light emitting portion | | |

As a result of the comparative measurement of the brightness of the cheering device (10) according to the present disclosure, and that of the comparison target device adopting a high-brightness light emitting diode, the cheering device (10) according to the present disclosure is superior to the comparison target device in terms of brightness distribution.

Thus, according to the present disclosure, included the lens portion condensing the light emitted by the light emitting diode and diffusing the condensed light to the light emitting portion, it is possible for the cheering device (10) to adopt a low power consuming light emitting diode with low applied voltage while providing the same luminous effect with a high power consuming light emitting diode requiring high applied voltage. Power consumption can also be reduced as the use of high-brightness light emitting diode is unnecessary, and the user's interest in cheering can be heightened as the user's fatigue decreases.

The usage of the cheering device according to the present disclosure is not limited to the cheering aid for arousing interest or entertaining effect as previously described, but the device can also be applied to a warning signal lamp attracting notice or a work signal lamp at the work place.

It is to be understood that the invention is not limited to the disclosed embodiment, but on the contrary, is intended to cover various modification and the equivalent arrangements which can be implemented by the ordinary skilled in the art, within the spirit and the scope of the appended claims. Accordingly, the scope of the present disclosure shall be determined only according to the attached claims.

[Description of Reference Numerals]

| | |
|---|---|
| 10: cheering device | 11: light emitting portion |
| 13: reflecting member | 15: covering member |
| 21: holder | 23: circuit board |
| 25: battery compartment portion | 27: battery |
| 29: power switch | 31: combining ring |
| 41: light emitting diode | 51: lens portion |
| 53: lens body | 55: condensing lens portion |
| 57: diffusing lens portion | 59: bump |
| 61: lens holder | 63: body holding portion |
| 65: groove | |

1. A cheering device, comprising
a light emitting portion emitting light;
a holder grabbable and supporting the light emitting portion;
at least one light emitting diode contained in the holder and emitting light;
a lens portion condensing the ray of light emitted by the light emitting diode and diffusing the condensed light to the light emitting portion; and
a reflecting member arranged in the light emitting portion, reflecting and penetrating the light emitted by the lens portion to be evenly diffused
wherein the lens portion comprises
a lens body diffusing the ray of light emitted by the light emitting diode to the light emitting portion, comprising a condensing lens portion which is dome shaped and condensing the light emitted by the light emitting diode, and a diffusing lens portion which is flat and diffusing the light passed through the condensing lens portion; and
a lens holder supporting the lens body on the holder,
wherein a pair of bumps is protruded in a radial direction on the circumference of the diffusing lens portion,
wherein the lens holder has a form of cylinder with both ends open,
including the top and the bottom, and comprises a body holding portion holding the lens body on the inside of the lens holder, and a pair of grooves formed on the circumference of one of the open ends,
wherein the lens body is combined to the body holding portion of the lens holder, and a pair of bumps is fitted into a pair of grooves at the same time.
